(19) United States
(12) Patent Application Publication
(10) Pub. No.: US 2008/0035865 A1
(43) Pub. Date: Feb. 14, 2008

(54) Extreme ultra violet light source device

(76) Inventors: Hiroshi Komori, Hiratsuka-shi (JP); Akira Endo, Tokyo (JP); Hakaru Mizoguchi, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/882,253

(22) Filed: Jul. 31, 2007

(30) Foreign Application Priority Data
Aug. 7, 2006 (JP) 2006-214482

(51) Int. Cl. H05G 2/00

(52) U.S. Cl. 250/504 R

(57) ABSTRACT

An extreme ultra violet light source apparatus in which both a mechanism of supplying a droplet target to a laser application position at a high speed and a mechanism of trapping charged particles generated from plasma are managed without disturbing a track of the target. The apparatus includes: a target nozzle that injects a target material toward a plasma generation point; an electric charge supply unit that charges the injected target material; an acceleration unit that accelerates the charged target material; a laser oscillator that applies a laser beam to the target material at the plasma generation point to generate plasma; and electromagnets that form a magnetic field at the plasma generation point such that the magnetic field has substantially straight lines of magnetic flux in substantially parallel with a traveling direction of the target material in the track of the target material.

### BACKGROUND OF THE INVENTION

1. Field of the Invention

The present invention relates to an extreme ultra violet (EUV) light source apparatus to be used as a light source of exposure equipment.

2. Description of a Related Art

Recent years, as semiconductor processes become finer, photolithography has been making rapid progress to finer fabrication. In the next generation, microfabrication of 100 nm to 70 nm, further, microfabrication of 50 nm or less will be required. Accordingly, in order to fulfill the requirement for microfabrication of 50 nm or less, for example, exposure equipment is expected to be developed by combining an EUV light source generating EUV light with a wavelength of about 13 nm and reduced projection reflective optics.

As the EUV light source, there are three kinds of light sources, which include an LPP (laser produced plasma) light source using plasma generated by applying a laser beam to a target (hereinafter, also referred to as “LPP EUV light source apparatus”), a DPP (discharge produced plasma) light source using plasma generated by discharge, and an SR (synchrotron radiation) light source using orbital radiation. Among them, the LPP light source has advantages that extremely high intensity close to black body radiation can be obtained because plasma density can be considerably made larger, that light emission of only the necessary waveband can be performed by selecting the target material, and that an extremely large collection solid angle of 2π steradian can be ensured because it is a point light source having substantially isotropic angle distribution and there is no structure surrounding the light source such as electrodes. Therefore, the LPP light source is thought to be predominant as a light source for EUV lithography requiring power of several tens of watts.

Here, a principle of generating EUV light in the LPP EUV light source apparatus will be briefly explained. By injecting a target material from a nozzle and applying a laser beam to the target material, the target material is excited and turned into plasma. Various wavelength components including extreme ultra violet (EUV) light are radiated from the plasma. Then, a desired wavelength component of them is selectively reflected and collected by using a collector mirror (an EUV collector mirror), and outputted to a unit using EUV light (e.g., exposure unit). For example, in order to collect EUV light having a wavelength near 13.5 nm, a collector mirror having a reflecting surface on which a multilayer film with alternately stacked molybdenum and silicon (Mo/Si multilayer film) is formed is used. A conceptual diagram of the LPP EUV light source apparatus is shown in FIG. 6 of Japanese Patent Application Publication JP-P2003-297737A.

In the LPP EUV light source apparatus, the influence of fast ions and fast neutral particles emitted from plasma is problematic. This is because the EUV collector mirror is located near the plasma and the reflecting surface of the mirror is sputtered and damaged by those particles. Nevertheless, the EUV collector mirror is required to have the high surface flatness of about 0.2 nm (rms), for example, in order to maintain the high reflectance, and thus, the EUV collector mirror is very expensive. Accordingly, the longer life of the EUV collector mirror is desired in view of reduction in operation costs of the EUV exposure equipment (exposure equipment using EUV light as a light source), reduction in maintenance time, and so on. The scattered materials from the plasma including fast ions and neutral particles, and the remains of the target material are called debris.

In order to reduce the influence of debris and improve the output of EUV light, JP-P2003-297737A discloses an EUV light source apparatus that supplies targets at a high repetition frequency and a high speed. The EUV light source apparatus includes a target supply unit having electric charge imparting means for imparting electric charge to the target and accelerating means for accelerating the charged target by using an electromagnetic field (page 2, FIG. 1). As disclosed in JP-P2003-297737A, by accelerating a droplet target to reach a plasma generation point earlier, the output of EUV light can be improved while the working distance is made longer.

Further, U.S. Pat. No. 6,987,279B2 discloses an extreme ultra violet light source device comprising a target supply unit for supplying a material to become a target, a laser unit for generating plasma by applying a laser beam to the target, a collection optical system for collecting extreme ultra violet light radiating from the plasma and emitting the extreme ultra violet light, and magnetic field generating means for generating a magnetic field within the collection optical system when supplied with current so as to trap charged particles emitted from the plasma. That is, in U.S. Pat. No. 6,987,279 B2, the fast ions emitted from the plasma are trapped by the effect of the magnetic field, and thereby, collision with the EUV collector mirror can be prevented. Further, U.S. Pat. No. 6,987,279 B2 also discloses that the neutral particles are applied with ultraviolet light to be ionized in order to trap the neutral particles having no charge in the similar way.

However, in application of both the technology of charging and accelerating a droplet target (JP-P2003-297737A) and the technology of trapping charged particles by the effect of the magnetic field (U.S. Pat. No. 6,987,279B2), the following problem will occur.

Generally, a moving charged particle is subject to Lorentz force in a direction perpendicular to a direction of the motion by an effect of a magnetic field. Here, given that the electric charge of the charged particle is “q”, the velocity is “v” (vector), and the magnetic flux density is “B” (vector), the Lorentz force “F” (vector) acting on the charged particle moving in the magnetic field is expressed by the following equation (1).
F=q(v×B) (1)
Accordingly, given that an angle formed between the velocity “v” and the magnetic flux density “B” is “θ”, the magnitude of the Lorentz force |F| is expressed by the following equation (2).
|F|=|q|·|v|·|B|·sin θ (2)
Further, the orientation of the Lorentz force “F” agrees with the orientation of the vector product v×B when the charge “q” is positive. Accordingly, charged particles having velocity components nonparallel to the magnetic flux density “B” (i.e., charged particles crossing the lines of magnetic flux) among the charged particles (charged debris) emitted from the plasma are trapped near the plasma generation point by the effect of the magnetic field.

However, in JP-P2003-297737A, since the droplet target is charged for acceleration, when the charged target crosses the lines of magnetic flux until the target reaches the laser application position, its track changes due to the Lorentz force “F”. Here, as clearly found from the equations (1) and (2), the magnitude of the Lorentz force |F| depends on the magnitudes of charge “q”, velocity “v”, and magnetic flux density “B”, and therefore, the track of the droplet target is unpredictable due to changes depending on the magnitudes.

As described above, in the LPP EUV light source apparatus, plasma is generated by applying a laser beam to a droplet target. For this purpose, it is desirable that the track of the droplet target is constantly stable. This is because, if the track of the droplet target changes, the alignment of the laser beam applied to the droplet target becomes defective, and thereby, the excitation intensity and the shape of the plasma to be generated, the number of times of plasma generation, and so on change. Consequently, the stability of EUV light becomes lower and available EUV light is reduced. Further, the operation cost and the maintenance cost of the EUV light source apparatus are increased due to reduction in utilization efficiency of the EUV light, and the performance of EUV exposure equipment is deteriorated due to lack of stability in luminance of the EUV light, and finally, the quality of semiconductor devices produced by the EUV exposure equipment will be unstable.

### SUMMARY OF THE INVENTION

The present invention has been achieved in view of the above-mentioned problems. A purpose of the present invention is, in an EUV light source apparatus, to manage both a mechanism of supplying a droplet target to a laser application position at a high speed and a mechanism of trapping charged particles generated from plasma by an effect of a magnetic field, without disturbing a track of the target.

In order to accomplish the above purpose, an extreme ultra violet light source apparatus according to one aspect of the present invention is an apparatus that emits extreme ultra violet light by irradiating a target material with a laser beam applied from a laser beam source and thereby turning the target material into plasma, and the apparatus includes: a target nozzle that injects a target material toward a predetermined plasma generation point; an electric charge supply unit that charges the target material injected from the target nozzle; an acceleration unit that accelerates the target material charged by the electric charge supply unit; a laser oscillator that applies a laser beam to the target material at the plasma generation point so as to generate plasma; and magnetic field forming means that forms a magnetic field at the plasma generation point, wherein the magnetic field has substantially straight lines of magnetic flux in substantially parallel with a traveling direction of the target material in a track of the target material.

According to the present invention, since the magnetic field for trapping the charged particles emitted from the plasma is formed to have the substantially straight lines of magnetic flux in substantially parallel with the traveling direction of the target material in the track of the target material, even when the charged target material is injected into such a region, a change of the track due to the effect of the magnetic field can be suppressed. Therefore, the target material is stably supplied to the plasma generation point, and both the technology of supplying the target materials at a high speed and the technology of trapping the charged particles are managed.

### BRIEF DESCRIPTION OF THE DRAWINGS

FIG. 1 shows a configuration of an extreme ultra violet light source apparatus according to the first embodiment of the present invention;

FIG. 2 shows a section along II-II shown in FIG. 1;

FIG. 3 is a diagram for explanation of an electron generation principle of a thermal electron emission electron gun;

FIG. 4 is a diagram for explanation of an electron generation principle of an electric field emission electron gun;

FIG. 5 is a schematic diagram showing the first configuration example of an ECR (electron cyclotron resonation) plasma generator;

FIG. 6 is a schematic diagram showing the second configuration example of an ECR (electron cyclotron resonation) plasma generator;

FIG. 7 is a schematic diagram showing a configuration example of a microwave plasma generator;

FIG. 8 is a schematic diagram showing a configuration example of a dielectric charger;

FIGS. 9A and 9B are diagrams for explanation of a principle of an induction accelerator;

FIGS. 10A and 10B are diagrams for explanation of a principal of an RF (radio frequency) accelerator;

FIG. 11 is a diagram for explanation of a principal of a Van de Graaff electrostatic accelerator;

FIG. 12 shows a configuration of an extreme ultra violet light source apparatus according to the second embodiment of the present invention;

FIG. 13 shows a configuration of an extreme ultra violet light source apparatus according to the third embodiment of the present invention;

FIG. 14 shows a configuration of an extreme ultra violet light source apparatus according to the fourth embodiment of the present invention;

FIG. 15 shows a section along XV-XV shown in FIG. 14;

FIG. 16 shows a configuration of the extreme ultra violet light source apparatus including a target position adjustment unit using an effect of an electric field;

FIG. 17 shows a configuration of the extreme ultra violet light source apparatus including a target position adjustment unit using an effect of a magnetic field;

FIG. 18 is a plan view showing an electromagnetic part shown in FIG. 17; and

FIG. 19 shows an example of using the target position adjustment unit shown in FIG. 14 as a unit of thinning target materials.

### DESCRIPTION OF THE PREFERRED EMBODIMENTS

Hereinafter, preferred embodiments of the present invention will be explained in detail by referring to the drawings. The same reference numerals are assigned to the same component elements and the description thereof will be omitted.

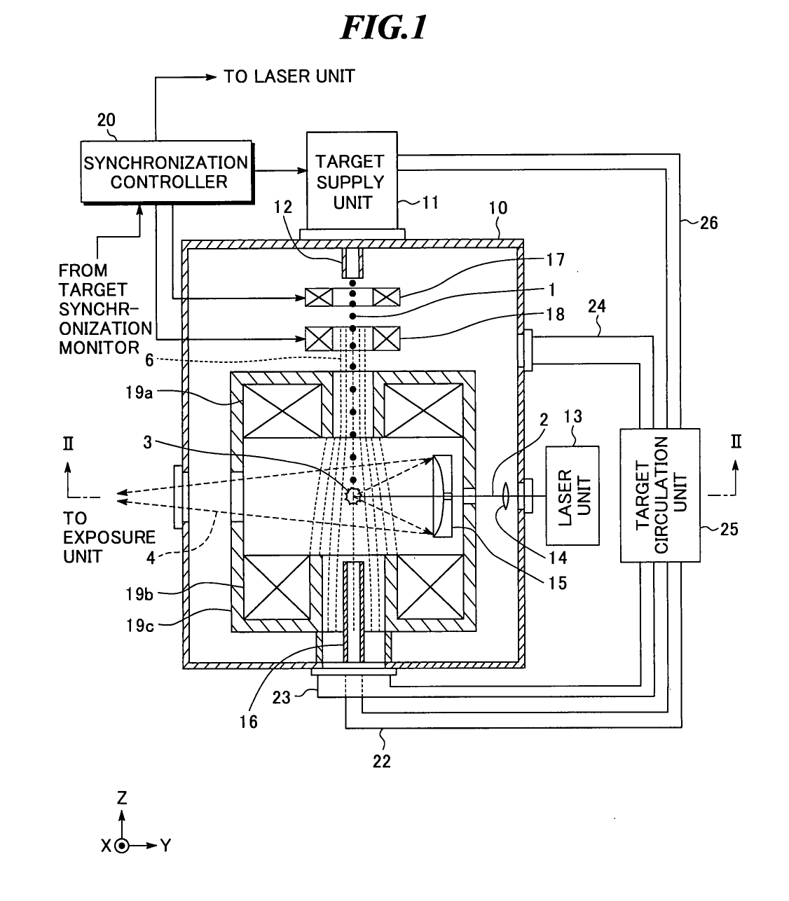

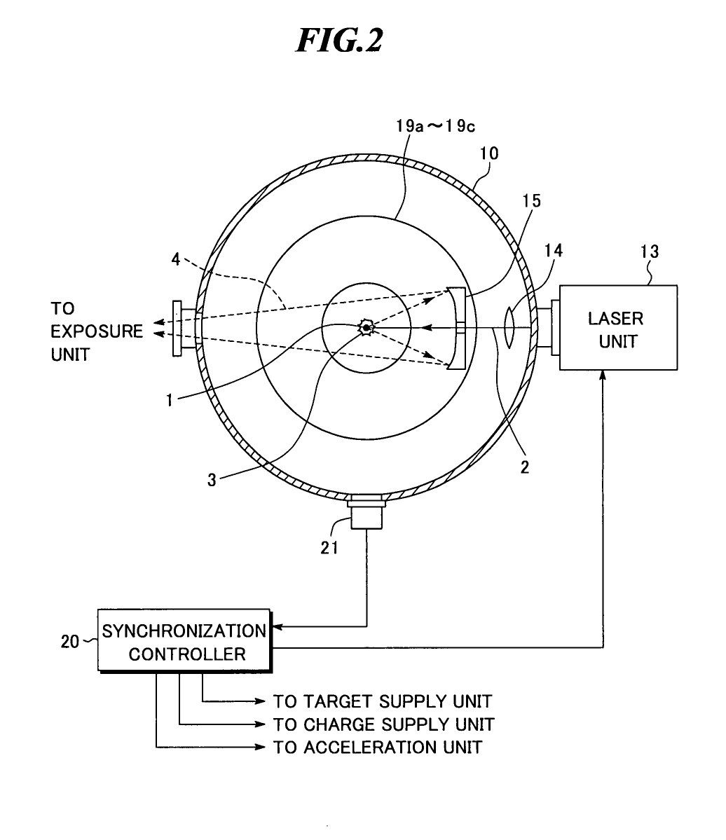

FIG. 1 shows a configuration of an extreme ultra violet (EUV) light source apparatus according to the first embodiment of the present invention. Further, FIG. 2 is a sectional view along II-II shown in FIG. 1. The EUV light source apparatus according to the embodiment employs a laser produced plasma (LPP) system of generating EUV light by applying a laser beam to a target material to excite the target material.

As shown in FIGS. 1 and 2, the EUV light source apparatus includes a chamber 10 in which EUV light is generated, a target supply unit 11, a target nozzle 12, a laser unit 13, a collective lens 14, an EUV collector mirror 15, a target collection cylinder 16, an electric charge supply unit 17, an acceleration unit 18, electromagnets 19a and 19b and a yoke 19c, a synchronization controller 20, and a target monitor 21. The EUV light source apparatus may further include a target collection pipe 22, an ion exhaust tube 23, a target exhaust tube 24, a target circulation unit 25, and a target supply tube 26.

The target supply unit 11 supplies the target nozzle 12 with a target material to be excited and thereby turned into plasma when irradiated with a laser beam. As the target material, xenon (Xe), mixture containing xenon as a primary component, argon (Ar), krypton (Kr), water (H₂O) or alcohol becoming gas under low-pressure condition, melted metal such as tin (Sn) and lithium (Li), water or alcohol in which fine metal particles of tin, tin oxide, copper, or the like are dispersed, ion solution formed by dissolving lithium fluoride (LiF) or lithium chloride (LiCl) in water, or the like can be used.

The state of the target material introduced into the target supply unit 11 may be gas, liquid, or solid. When a target material in the gas state at normal temperature like xenon, for example, is used as a liquid target, the xenon gas is pressurized and cooled in the target supply unit 11 and the liquefied xenon is supplied to the target nozzle 12. On the other hand, when a material in the solid state at normal temperature like tin, for example, is used as a liquid target, tin is heated in the target supply unit 11 and the liquefied tin is supplied to the target nozzle 12.

The target nozzle 12 injects the target material supplied from the target supply unit 11 to feed the target material in a droplet state to a predetermined position (plasma generation point) within the vacuum chamber 10. The target nozzle 12 includes a vibration mechanism employing piezoelectric element or the like, and generates droplets from the target material according to the following principle. That is, according to Rayleigh's stability theory of microdisturbance, when a target jet having a diameter “d” and flowing at a velocity “v” is vibrated at a frequency “f′ to be disturbed, in the case where a wavelength “λ” (λ=v/f) of the vibration generated in the target jet satisfies a predetermined condition (e.g., λ/d=4.51), uniformly-sized droplets are repeatedly formed at the frequency “f”. The frequency “f” is called Rayleigh frequency.

The laser unit 13 is a laser beam source capable of pulse oscillation at a high repetition frequency (e.g., the pulse width is about several nanoseconds to several tens of nanoseconds, and the repetition frequency is about 1 kHz to 10 kHz), and emits a laser beam 2 to be applied to the target material 1 to turn the target material 1 into plasma. Further, the collective lens 14 collects the laser beam 2 outputted from the laser unit 13 and applies the laser beam 2 to the plasma generation point (hereinafter, also referred to as “laser application position”). In place of the collective lens 14, collective optics employing other collection optical component or plural optical components in combination may be used.

Such a laser beam 2 is applied to the target material 1, and thereby, plasma 3 is generated and various wavelength components are radiated from the plasma.

The EUV collector mirror 15 is collective optics that collects a predetermined wavelength component (e.g., EUV light near 13.5 nm) from among the various wavelength components radiated from the plasma 3. The EUV collector mirror 15 has a concave reflecting surface on which a molybdenum (Mo)/silicon (Si) multilayer film for selectively reflecting the EUV light near 13.5 nm, for example, is formed. EUV light 4 is reflected in a predetermined direction (in inverted Y direction in FIG. 1) and collected by the EUV collector mirror 15, and then, outputted to an exposure unit, for example. The collective optics of EUV light is not limited to the EUV collector mirror shown in FIG. 1. Though the collective optics may be configured by employing plural optical components, it is necessary that the collective optics is reflection optics for suppressing absorption of EUV light 4.

The target collection cylinder 16 is located in a position facing the target nozzle 12 with the plasma generation point in between. The target collection cylinder 16 collects the target material that has been injected from the target nozzle 12 but not has been applied with the laser beam and not has been turned into plasma. Thereby, the contamination of EUV collector mirror 15 and so on due to the scattered unwanted target material is prevented, and reduction in degree of vacuum is prevented.

The electric charge supply unit 17 is an electron gun, ECR (electron cyclotron resonation) plasma generator, microwave plasma generator, or dielectric charger, for example, and charges the target material 1 by supplying electric charge thereto.

The acceleration unit 18 is an electrostatic accelerator, dielectric accelerator, or RF (radio frequency) accelerator, for example, and accelerates the charged target material 1 by an effect of an electric and/or an effect of a magnetic field. Thereby, the working distance can be made longer without causing reduction in output of EUV light.

The specific configurations of the electric charge supply unit 17 and the acceleration unit 18 will be explained later.

Each of the electromagnets 19a and 19b includes a coil winding, a cooling mechanism for cooling the coil winding, and so on. Further, desirably, the yoke (a member to be used for inducing magnetic flux like electromagnetic soft iron) 19c is provided for the electromagnets 19a and 19b. A power supply unit and a controller (not shown) are connected to these electromagnets 19a and 19b, and currents supplied to the respective electromagnets 19a and 19b are adjusted for forming a desired magnetic field within the vacuum chamber 10.

The coils of the electromagnets 19a and 19b are oppositely provided in parallel or substantially parallel with each other such that the centers of openings are aligned, and thereby, the electromagnets 19a and 19b constitute a pair of mirror coils. The pair of mirror coils form a mirror magnetic field in a region including the plasma generation point when currents flowing in the same direction are supplied thereto.

Here, the mirror magnetic field refers to a magnetic field in which the magnetic flux density is higher near the coils of the electromagnets 19a and 19b and the magnetic flux density is lower in the middle between the coils. Typically, in the mirror magnetic field to be used in magnetic confinement nuclear fusion or the like, the magnetic field design, which increases the mirror ratio, is made for improvement in an effect of confinement of ions and plasma. However, in the embodiment, for the purpose of efficiently exhausting the charged particles (fast ions and so on emitted from the plasma 3) in the direction of lines of magnetic flux (Z-axis direction), the coils of the electromagnets 19a and 19b or yoke 19c are designed such that the mirror ratio is decreased. The mirror ratio refers to a ratio of the maximum magnetic flux density B₁ near the coils to the minimum magnetic flux density B₀ in the middle between the two coils (i.e., B₁/B₀).

In such a mirror magnetic field, a charged particle is subject to Lorentz force and moves within a plane perpendicular to lines of magnetic flux while traveling in an orbiting track, and trapped near the Z-axis. Further, when the charged particle has a velocity component in the Z-direction, the particle moves while traveling in a spiral track along the Z-direction, and is exhausted to the outside of the electromagnets 19a and 19b. Thereby, the charged particle is prevented from flying near the EUV collector mirror 15 and contaminating or damaging the mirror.

Further, in the embodiment, the electromagnets 19a and 19b generate magnetic fields different in intensity from each other, and thereby, as shown by the lines of magnetic flux 6 in FIG. 1, the resultant magnetic field becomes vertically asymmetric with respect to the plane perpendicular to the central axis of the lines of magnetic flux at the position of the plasma 3. FIG. 1 shows the lines of magnetic flux 6 in the case where the magnetic field at the electromagnet 19a side is stronger than the magnetic field at the electromagnet 19b side. Therefore, the charged particle trapped by the effect of the magnetic field is apt to be guided toward the lower magnetic flux density (downwardly in FIG. 1). Consequently, the charged particle can be actively guided in the direction of the target collection cylinder 16 and the ion exhaust tube 23 without staying near the plasma generation point.

Furthermore, in the embodiment, the form of the magnetic field is controlled such that the lines of magnetic flux 6 are substantially straight and in substantially parallel with the traveling direction of the target material 1 in the vicinity of the track of the target material 1. In other words, the region where the lines of magnetic flux 6 are substantially straight lines is formed, and the target material 1 is injected from the target nozzle 12 along the straight-line region toward the plasma generation point. Thereby, the velocity vector of the charged target material 1 and the magnetic flux density vector are in parallel, and the target material 1 no longer crosses the lines of magnetic flux 6. Consequently, the Lorentz force acting on the charged target material 1 can be reduced and the change of the track of the target material 1 can be suppressed.

Since the electromagnets 19a and 19b and yoke 19c are used within the vacuum chamber 10, they are hermetically sealed in a container made from a non-magnetic metal such as stainless steel and aluminum or made from ceramics so as to keep the degree of vacuum within the chamber and prevent emission of contaminants. Thereby, the coil windings and so on are isolated from the vacuum space within the chamber.

In order to change the intensity of the magnetic fields generated by the respective electromagnets 19a and 19b from each other, the intensity of currents supplied to the electromagnets 19a and 19b may be changed from each other, or a number of turns and/or a diameter of the coils may be changed between the electromagnets 19a and 19b. For more information on the mirror magnetic field and the exhaust action of charged particles by the magnetic field, refer to U.S. Pat. No. 6,982,279 B2 and Dwight R. Nicholson, “Introduction to Plasma Theory” (John Wiley & Sons, Inc.), chapter 2, section 6.

In the embodiment, the electromagnet coils are used for forming the mirror magnetic field, however, superconducting magnets or permanent magnets may be used instead.

The synchronization controller 20 controls the operation of the electric charge supply unit 17 and the acceleration unit 18 based on the output signal of the target monitor 21, which will be described later, such that the target material 1 reaches the plasma generation point at predetermined timing, and synchronously controls the operation timing of the laser unit 13. This is because the EUV light source apparatus applies laser beam (the laser beam 2) in pulse width of about several nanoseconds to several tens of nanoseconds, for example, in view of improvement in EUV conversion efficiency.

Referring to FIG. 2, the target monitor 21 includes a CCD camera or a photosensor array in which photosensors are linearly arranged and, when the target material 1 passes through a predetermined position, the target monitor 21 outputs a signal representing the time. The target monitor 21 may monitor the laser application position, or another position as long as it is correlated with the time when the target material 1 reaches the laser application position. For example, in the case where the target monitor 21 monitors a position in the track of the target material 1, the time when the target material 1 passes through the laser application position can be calculated based on the distance between the monitored position and the laser application position and the velocity of the target material 1.

Referring to FIG. 1 again, the target collection pipe 22 transports the target material collected by the target collection cylinder 16 to the target circulation unit 25.

The ion exhaust tube 23 is provided to be connected to the opening of the electromagnet 19b (or the yoke 19c) and collects the charged particles trapped by the magnetic field and guided outside of the electromagnet 19b, and transports them to the target circulation unit 25.

The target exhaust tube 24 is a path for exhausting the target material remaining within the chamber 10 to the outside of the chamber 10.

The target circulation unit 25 is a unit for reusing the residual target material and charged particles collected via the target collection pipe 22, the ion exhaust tube 23, and the target exhaust tube 24. The target circulation unit 25 includes a suction power source (suction pump), a refining mechanism for the target material, and a pressure feed power source (pressure feed pump). The target circulation unit 25 refines the target material and so on collected from within the chamber 10 in the refining mechanism and pressure-feeds them via the target supply tube 26 to the target supply unit 11.

In order to assist the pumping action by the target circulation unit 25, exhaust pumps may be separately provided for the target collection pipe 22, the ion exhaust tube 23, and the target exhaust tube 24.

As explained above, according to the embodiment, since the magnetic field for trapping the charged particles emitted from the plasma is formed to provide substantially straight lines of magnetic flux in the track of the target material and the charged target material is introduced along the straight part of the lines, change in the track of the target material due to the effect of the magnetic field can be suppressed. Thereby, the target material can be supplied to a fixed position (laser application position) at predetermined timing. Therefore, the laser beam can be reliably applied in the form of pulses to the target material, and EUV light can be stably emitted. Consequently, the reduction in use efficiency of EUV light can be prevented and the stable illuminance can be obtained in the extreme ultra violet light source apparatus. Thereby, the reduction in operation costs of the EUV light source apparatus and the improvement in operation availability can be realized, and further, the exposure performance becomes stable in the exposure equipment employing the EUV light source apparatus. Thus, the improvement in operation availability and exposure treatment performance can be realized and the quality of semiconductor devices can be stabilized.

Next, a unit used as the electric charge supply unit 17 shown in FIG. 1 will be explained in detail.

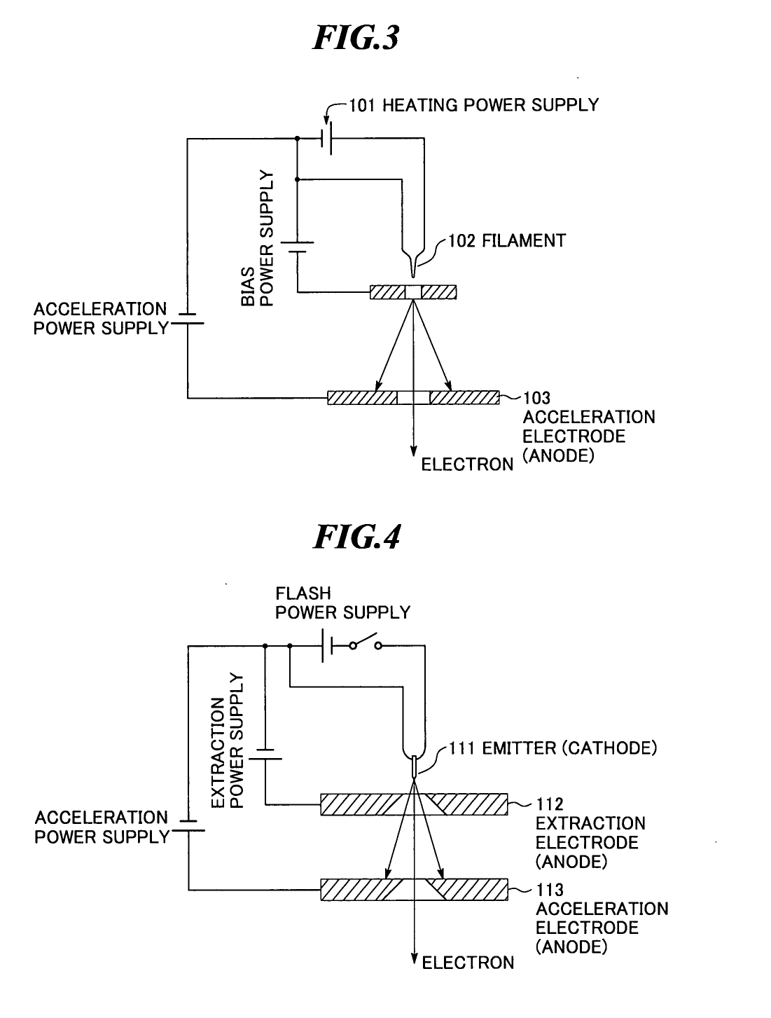

FIG. 3 is a diagram for explanation of an electron generation principle of a thermal electron emission electron gun. As shown in FIG. 3, a filament 102 is heated by a heating power supply 101, and thereby, thermal electrons are generated from the tip of the filament 102. The thermal electrons are accelerated by an acceleration electrode (anode) 103 and emitted toward the target material 1 (FIG. 1). In this regard, when the electron is applied to the target material 1 while the acceleration energy of the electron is made relatively low (e.g., 100 eV or less), the electron attaches to the target material 1. Thereby, the target material 1 is negatively charged. On the other hand, when the electron is applied to the target material 1 while the acceleration energy of the electron is made relatively high (e.g., more than 100 eV), a secondary electron is emitted from an atom of the surface of the target material because of the collision with energy of the electron. Thereby, the target material 1 is positively charged.

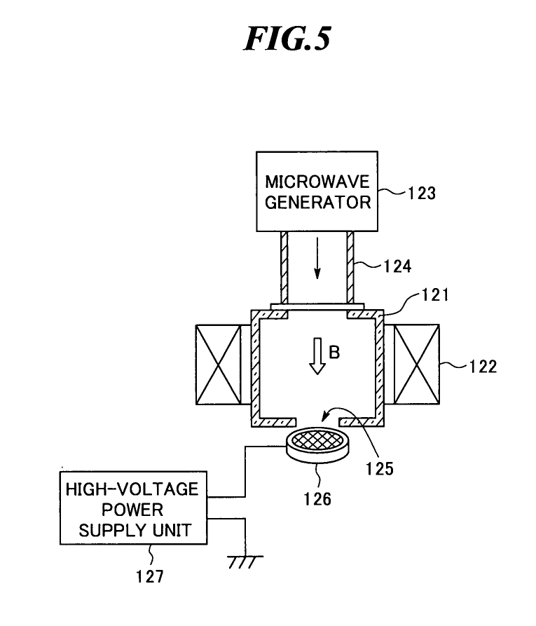

FIG. 4 is a diagram for explanation of an electron generation principle of an electric field emission electron gun. As shown in FIG. 4, a strong electric field is formed by an extraction electrode (anode) 112, and thereby, an electron is generated from the tip of an emitter (cathode) 111. The electron is accelerated by an acceleration electrode (anode) 113 and emitted toward the target material 1 (FIG. 1). Also, in this case, when the electron with relatively low acceleration energy (e.g., 100 eV or less) is applied to the target material 1, the electron attaches to the target material 1 and the target material 1 is negatively charged. On the other hand, when the electron with relatively high acceleration energy (e.g., more than 100 eV) is applied to the target material 1, a secondary electron is emitted from an atom of the surface of the target material and the target material 1 is positively charged.

FIG. 5 is a schematic diagram showing the first configuration example of ECR plasma generator. A discharge chamber 121 shown in FIG. 5 is formed by a quartz tube, for example, and a neutral particle gas (plasma gas) at appropriate pressure is supplied into the chamber. As the neutral particle gas, xenon (Xe), argon (Ar), helium (He), or the like is used. Further, within the discharge chamber 121, a high magnetic field (e.g., 875 gauss) is formed by an electromagnet 122 provided around the chamber. Accordingly, an electron present within the discharge chamber 121 makes circling motion (cyclotron motion) to wrap the lines of magnetic force. Into the discharge chamber 121, microwaves (electric field) are introduced from a microwave generator 123 via a microwave waveguide 124. When the electric field formed in the discharge chamber 121 changes at the same frequency as that of the cyclotron motion of the electron, the electron obtains energy from the electric field and comes into a so-called cyclotron resonant state. For example, when microwave at 2.45 GHz is introduced into a magnetic field of 875 gauss, the cyclotron resonant state is caused.

Here, in view of effective use of microwave energy, using clockwise circularly polarized microwave is advantageous. The reason is as follows. That is, as shown in FIG. 5, the case where microwave is introduced from a direction aligned with the magnetic flux (the direction of the arrow) into the discharge chamber 121, in which a magnetic field with downward magnetic flux (magnetic flux density B) is formed, is considered. When horizontally polarized microwave is applied to an electron within the discharge chamber 121, the electron is accelerated only twice per cycle of the electron cyclotron motion. On the other hand, when the clockwise circularly polarized microwave is applied to an electron within the discharge chamber 121, the polarization direction of the microwave and the rotational direction of the electron cyclotron motion are constantly coincident with each other and the electron can be continuously accelerated by the microwave. At that time, by applying the microwave from a side at which the magnetic flux is higher toward a side at which the magnetic flux is lower, high-density plasma more than electron critical density can be generated. For more information on the generation principle of microwave plasma, refer to The Institute of Electrical Engineers of Japan, Microwave Plasma Research Expert Committee, “Technology of Microplasma”, 1st edition, Ohmsha, Ltd., Sep. 25, 2003, pp. 18-21.

The electrons accelerated in the cyclotron resonant state collide with surrounding neutral particles and ionize them. Then, the chain reaction of the ionization due to collision of electrons and the energy supply from the electric field to the electrons occurs, and thereby, plasma is generated. The plasma is passed through an orifice 125 and radiated from the discharge chamber 121 toward the space within the vacuum chamber 10 (FIG. 1), i.e., the track of the target 1.

As shown in FIG. 5, an extraction electrode 126 having a mesh-like opening is provided outside of the orifice 125. Further, a high-voltage power supply unit 127 is connected to the extraction electrode 126. While a negative high-voltage is applied to the extraction electrode 126, the plasma radiated from the orifice 125 is allowed to pass through the opening of the extraction electrode 126. Thereby, only the positively charged plasma can be selectively extracted. Such plasma is applied to the target material 1 to positively charge the target material 1.

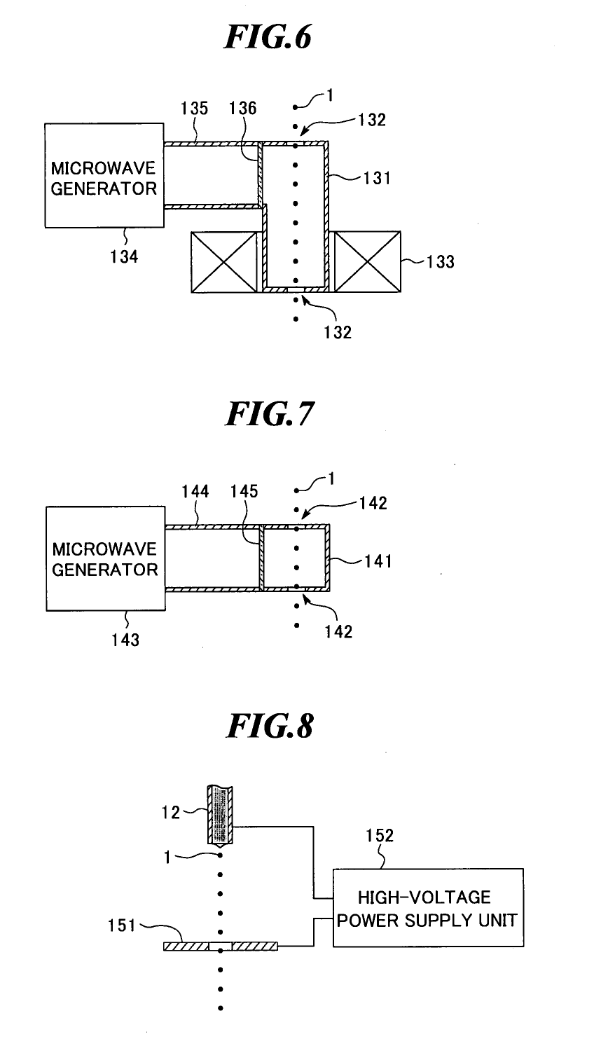

FIG. 6 is a schematic diagram showing the second configuration example of ECR plasma generator.

In FIG. 6, a microwave waveguide 135 is bent in an L-shape, and the part partitioned by a window 136 is used as a discharge chamber 131. Therefore, the discharge chamber 131 is formed of a conducting non-magnetic metal material such as copper and aluminum such that the discharge chamber 131 also serves as a waveguide and a magnetic field is formed therein, as will be described later. At opposite two locations (the upper portion and the lower portion in FIG. 6) of the discharge chamber 131, orifices 132 for passing through the target material 1 injected from the target nozzle 12 (FIG. 1) are formed. Further, the interior of the discharge chamber 131 is filled with a neutral particle gas such as xenon (Xe), argon (Ar), or helium (He) as a plasma gas. Alternatively, when xenon is used as the target material 1, the xenon gas left within the vacuum chamber 10 (FIG. 1) may be used as a plasma gas.

When a high magnetic field is formed in the discharge chamber 131 by an electromagnet 133 provided around the discharge chamber 131 and microwave (electric field) is introduced from a microwave generator 134 via the waveguide 135 and the window 136 into the discharge chamber 131, plasma is generated within the discharge chamber 131. The principle of plasma generation is the same as that described in the first configuration example. The target material 1 is passed through the plasma region, and the target material 1 is charged. Here, electrons typically move at higher velocities than those of ions in plasma, and the electrons have greater chance of colliding with the target material 1. Accordingly, in the configuration example, the target material 1 is negatively charged.

FIG. 7 is a schematic diagram showing a configuration example of microwave plasma generator.

In FIG. 7, apart of microwave waveguide 144 is partitioned by a window 145 to form a discharge chamber 141. The discharge chamber 141 is formed of a metal material and closed at the terminal end for confinement and vibration of microwave. Further, at opposite two locations (the upper portion and the lower portion in FIG. 7) of the discharge chamber 141, orifices 142 for passing through the target material 1 injected from the target nozzle 12 (FIG. 1) are formed. The orifices 142 are provided such that the target material 1 passes through a region where the electric field intensity of the stationary wave generated within the discharge chamber 141 is the strongest.

When microwave is introduced from a microwave generator 143 via the waveguide 144 and the window 145 into the discharge chamber 141, the microwave is reflected at the terminal end of the discharge chamber 141 and stationary wave is generated within the discharge chamber 141. Thereby, microwave plasma is generated within the discharge chamber 141. Then, the target material 1 is injected from the target nozzles 12 and passed through the microwave plasma formed in the region where the electric field intensity is the strongest in the stationary wave. Thereby, the target material 1 is negatively charged. The reason of being negatively charged is the same as explained in the second example.

FIG. 8 is a schematic diagram showing a configuration example of dielectric charger. An electrode 151, in which an opening for passing through the target material 1 is formed, is provided at the downstream side of the target nozzle 12 for injecting the target material 1. A high voltage of about 1 kV, for example, is applied by a high-voltage power supply unit 152 between the target nozzle 12 and the electrode 151. Thereby, when the continuous flow of the target material passing within the target nozzle 12 is divided into droplets, dielectric polarization is caused by the external electrode, and consequently, the target material 1 is charged.

Next, a unit used as the acceleration unit 18 shown in FIG. 1 will be explained in detail.

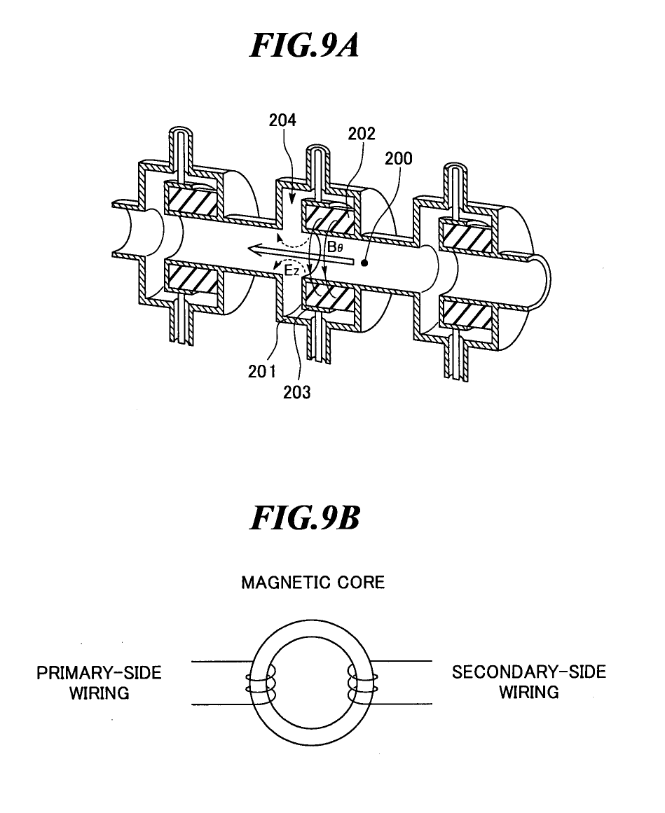

FIGS. 9A and 9B are diagrams for explanation of a principle of an induction accelerator. As shown in FIG. 9A, the induction accelerator includes a conducting material 201 forming an acceleration cavity (a path for passing through an accelerated particle 200), a magnetic material 202 placed within the conducting material 201, and a wiring 203 formed around the magnetic material 202. The magnetic material 202 is provided around the path of the particle 200. As shown in FIG. 9B, the magnetic material 202 corresponds to a magnetic core of a transformer for generating a step-like induction electric field within the acceleration cavity. Further, the wiring 203 corresponds to a primary-side wiring of the transformer and the conducting material 201 corresponds to a secondary-side wiring of the transformer. When a voltage is supplied to the wiring 203 (primary-side wiring) and a magnetic field (magnetic flux density B₀) is generated within the magnetic material 202, an induced electromotive force is generated in the conducting material 201 (secondary-side wiring) around the same magnetic material 202, and an induction electric field E_{z} is generated in a gap 204 between the conducting material 201 and the wiring 203. The charged particle 200 is accelerated by the electric field E_{z} when passing through the gap 204.

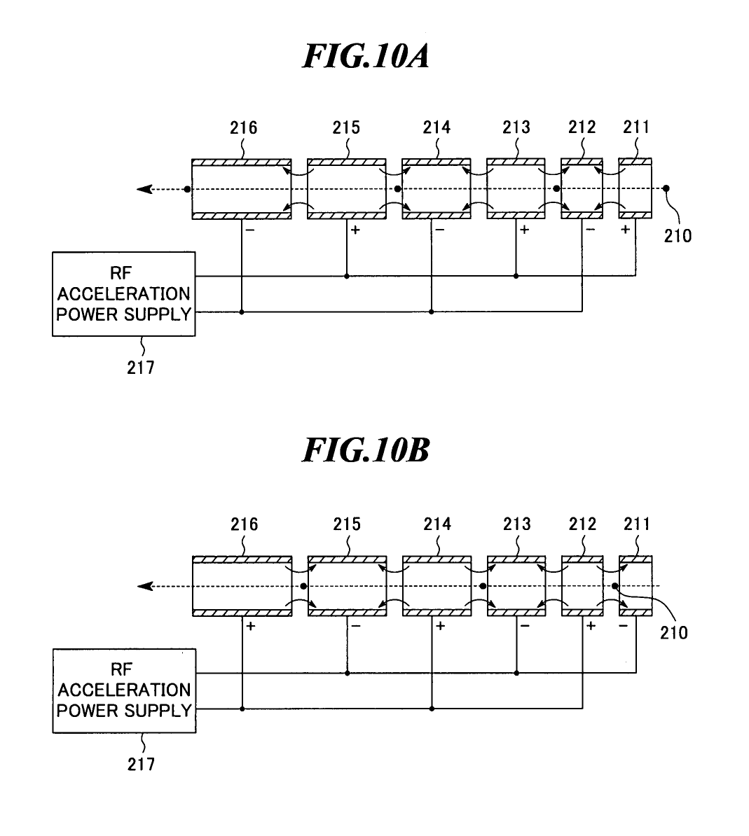

FIGS. 10A and 10B are diagrams for explanation of a principal of an RF accelerator. The RF accelerator includes plural cylindrical acceleration cavities 211-216 formed of copper or the like. These acceleration cavities 211-216 are alternately wired together and connected to the RF acceleration power supply 217. Further, the lengths of the acceleration cavities 211-216 are designed to be gradually longer according to the velocity of a charged particle 210 introduced from the acceleration cavity 211 side. The RF acceleration power supply 217 applies an alternating-current voltage to each of the acceleration cavities 211-216 in synchronization with the timing when the charged particle 210 passes through the acceleration cavities 211-216. FIG. 10A shows a condition of an electric field at a certain moment, and FIG. 10B shows a condition of the electric field at another moment. For example, in the case where the charged particle has negative charge, when the charged particle 210 passes through a certain gap, the voltage application timing is adjusted such that the particle moves from the negative acceleration cavity toward the positive acceleration cavity. Thereby, the charged particle 210 is gradually accelerated when it passes through each gap.

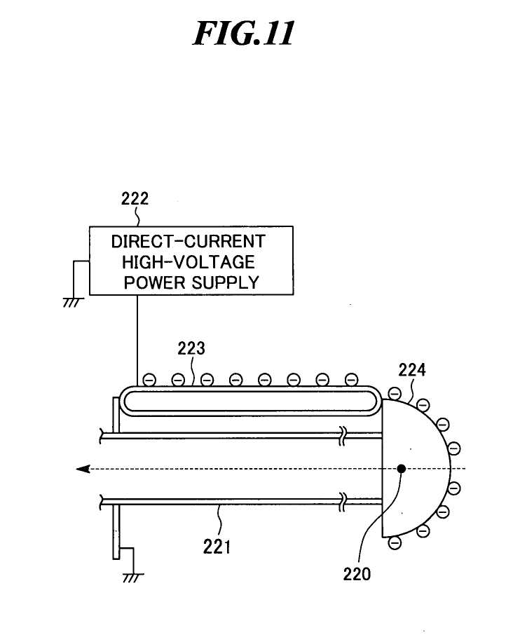

FIG. 11 is diagrams for explanation of a principal of a Van de Graaff electrostatic accelerator. The Van de Graaff electrostatic accelerator includes an accelerating tube 221, a direct-current high-voltage power supply 222, a charge carrier unit 223, and a cap 224 that accumulates charge. The charge carrier unit 223 is a belt conveyer formed of an insulating material, for example, and carries charge supplied from the direct-current high-voltage power supply 222 to the cap 224. Thereby, a high voltage (e.g., several hundreds of kilovolts to several megavolts) is generated between the cap 224 and the ground potential, and a charged particle 220 is accelerated within the accelerating tube 221 by using the voltage as an acceleration electric field.

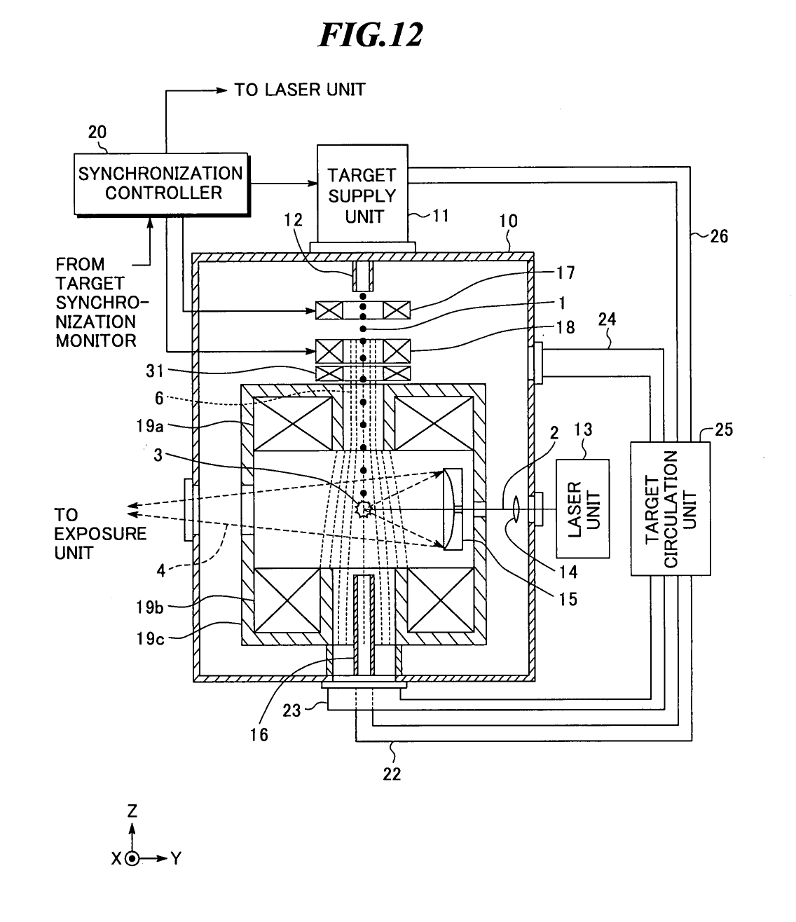

Next, an extreme ultra violet light source apparatus according to the second embodiment of the present invention will be explained with reference to FIG. 12.

The extreme ultra violet light source apparatus according to the embodiment is further provided with an auxiliary magnetic field forming unit 31 in addition to the extreme ultra violet light source apparatus shown in FIG. 1. The rest of the configuration is the same as that shown in FIG. 1.

Here, in the magnetic field formed by the electromagnets 19a and 19b, lines of magnetic flux are diverged as they are apart from the electromagnet 19a. Further, when the yoke 19c is provided to the electromagnets 19a and 19b, the lines of magnetic flux are more easily diverged. Accordingly, in the embodiment, the auxiliary magnetic field forming unit 31 is provided for making the lines of magnetic flux substantially straight in the broader region and in substantially parallel with the traveling direction of the target material 1. Thereby, change in the track of the target material 1 is more reliably suppressed.

The location of the auxiliary magnetic field forming unit 31 is not limited to the part below the acceleration unit 18, but may be anywhere between the electric charge supply unit 17 and the electromagnet 19a.

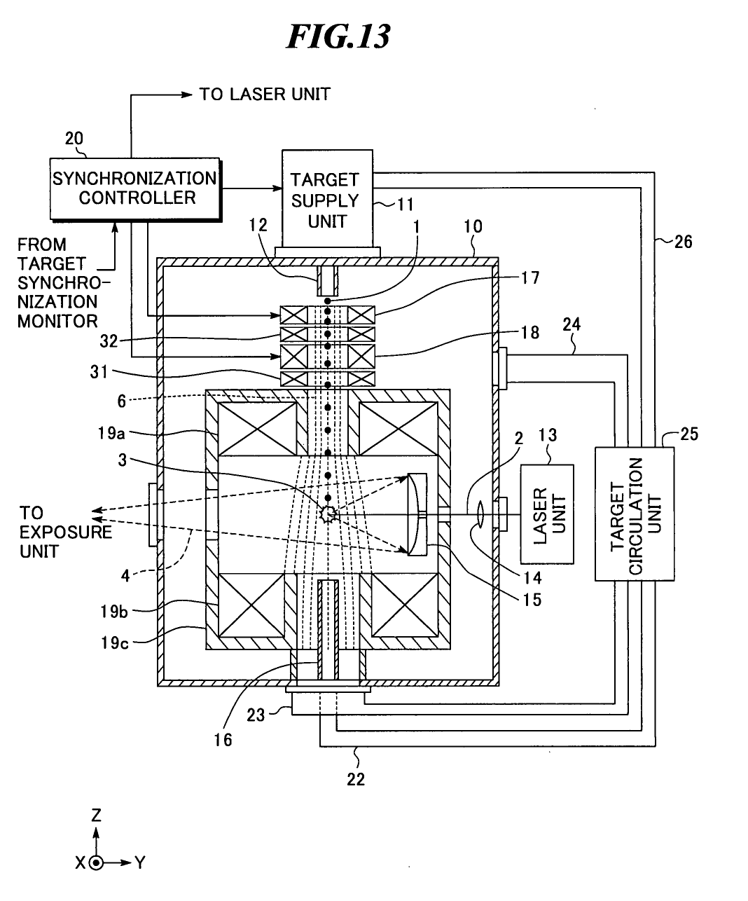

Next, an extreme ultra violet light source apparatus according to the third embodiment of the present invention will be explained with reference to FIG. 13.

The extreme ultra violet light source apparatus according to the embodiment is further provided with an auxiliary magnetic field forming unit 32 above the acceleration unit 18 in addition to the extreme ultra violet light source apparatus shown in FIG. 12.

Here, when charge is provided to the target material 1 by the electric charge supply unit 17, the material is immediately affected by the magnetic field. Accordingly, in the embodiment, the auxiliary magnetic field forming unit 32 is provided for broadening the region where the lines of magnetic flux are made substantially straight and in substantially parallel with the traveling direction of the target material 1. Thereby, change in the track of the charged target material 1 is more reliably suppressed. As the auxiliary magnetic field forming unit 32, an electromagnet, superconducting magnet, or permanent magnet may be used.

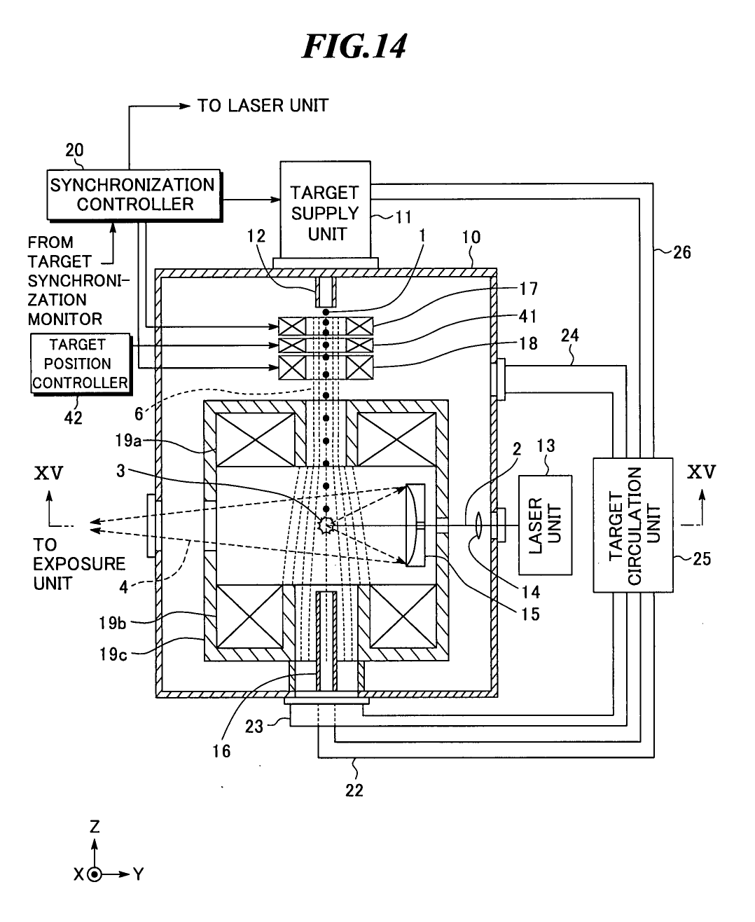

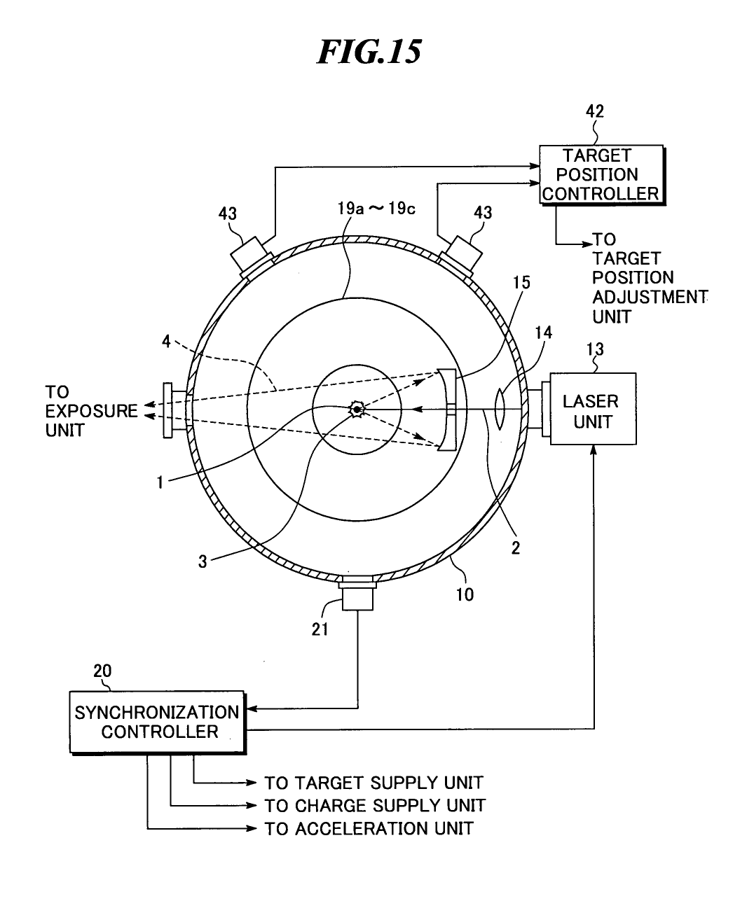

Next, an extreme ultra violet light source apparatus according to the fourth embodiment of the present invention will be explained. FIG. 14 shows a configuration of the extreme ultra violet light source apparatus according to the embodiment, and FIG. 15 is a sectional view along XV-XV shown in FIG. 14. The extreme ultra violet light source apparatus according to the embodiment is further provided with a target position adjustment unit 41, a target position controller 42, and a target position monitor 43 in addition to the extreme ultra violet light source apparatus shown in FIG. 1. The rest of the configuration is the same as that shown in FIG. 1.

The target position adjustment unit 41 adjusts the position of the target material 1 under the control of the target position controller 42 such that the target material 1 supplied with charge may pass through the center of the magnetic field (i.e., on the axis of the plasma generation point). As the target position adjustment unit 41, a unit that exerts a dynamic action like an electric field or magnetic field on the charged target is used.

The target position controller 42 controls the operation of the target position adjustment unit 41 based on a detection signal outputted from the target position monitor 43.

The target position monitor 43 as shown in FIG. 15 includes a CCD camera or photosensor array, in which photosensors are linearly arranged, and the target position monitor 43 detects the position of the target material 1 relative to the laser application position (plasma generation point). The position where the target position monitor 43 is provided may be a position directly facing the laser application position or any position as long as it is correlated with the position of the target material 1 with respect to the laser application position. Further, as shown in FIG. 15, the position detection accuracy of the target material 1 can be improved by providing plural target position monitors 43 facing the target material 1 from plural directions different from one another.

According to the embodiment, the position of the charged target material 1 is adjusted such that the charged target material 1 accurately enters the region where the lines of magnetic flux of the mirror magnetic field are substantially straight, and thus, change in the track of the target material 1 can be more effectively suppressed.

Next, a specific configuration of the target position adjustment unit 41 shown in FIG. 14 will be explained.

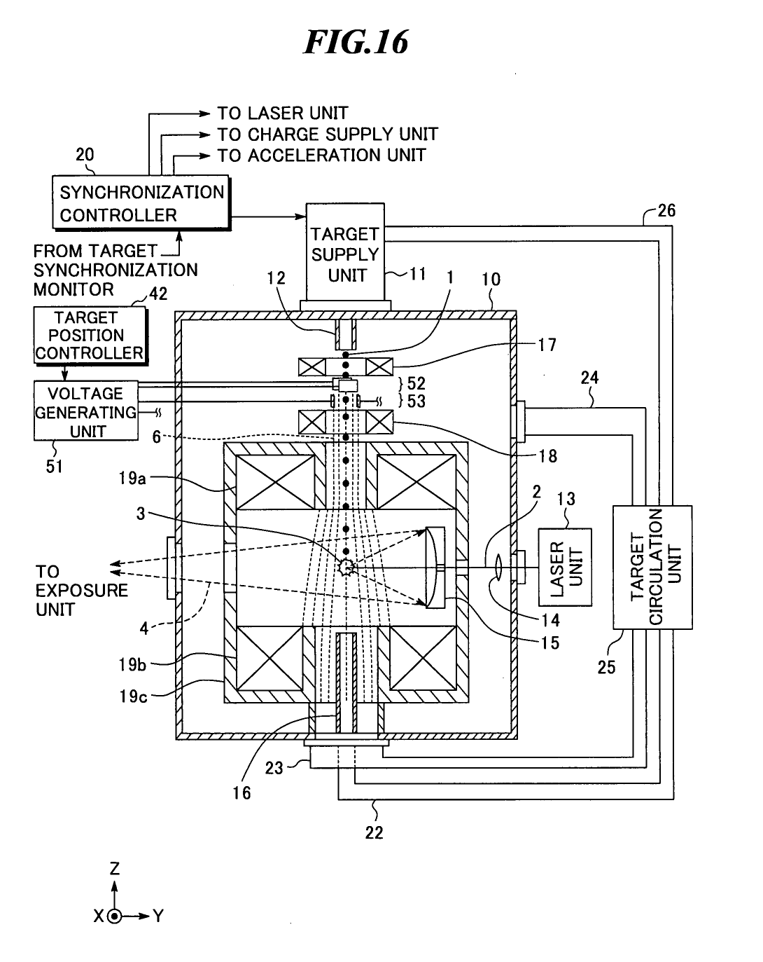

An extreme ultra violet light source apparatus shown in FIG. 16 has a voltage generating unit 51 and two pairs of electrodes 52 and 53 as a target position adjustment unit, and adjusts the position of the target material 1 by the effect of an electric field.

The voltage generating unit 51 supplies a pulsing or continuous high voltage to the electrode pairs 52 and 53 under the control of the target position controller 42.

Each of the electrode pairs 52 and 53 includes two electrode plates oppositely provided in parallel with each other with the track of the target material 1 in between. The electrode pair 52 is provided such that an electric field in the X-direction is formed between the two electrode plates, and the electrode pair 53 is provided such that an electric field in the Y-direction is formed between the two electrode plates.

When the charged material 1 is passed through the region where the electric fields in the two directions different from each other are formed by the electrode pairs 52 and 53, respectively, the position of the target material 1 is two-dimensionally adjusted. The amounts of displacement of the target material 1 in the X-direction and the Y-direction are controlled by the voltage values supplied from the voltage generating unit 51 to the electrode pairs 52 and 53.

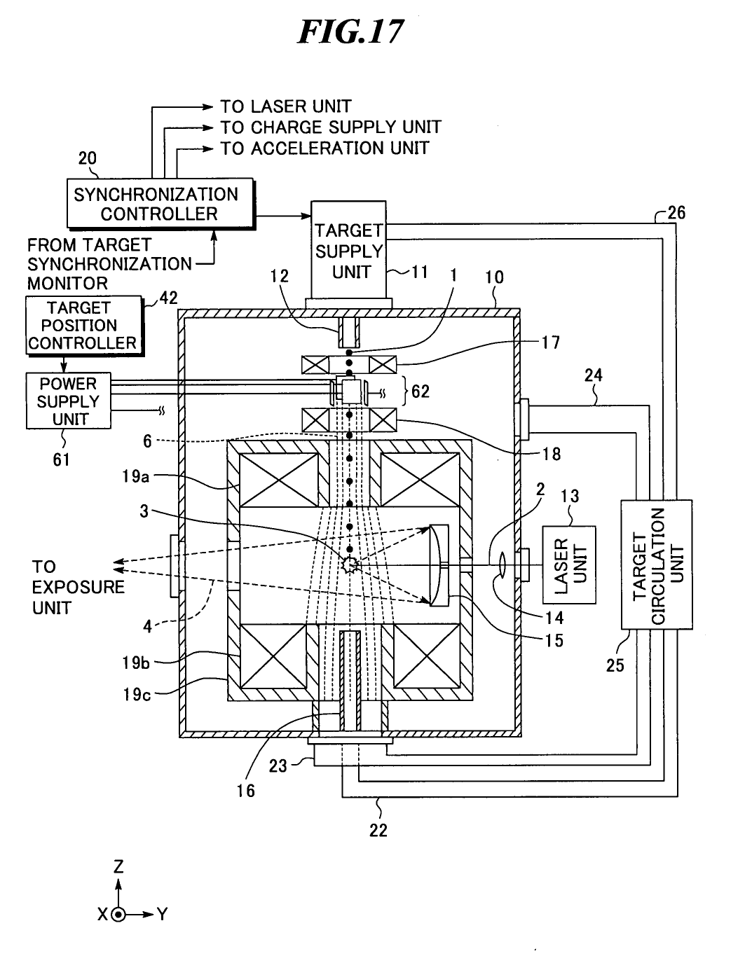

An extreme ultra violet light source apparatus shown in FIG. 17 includes a power supply unit 61 and an electromagnetic part 62 as a target position adjustment unit, and adjusts the position of the target material 1 by the effect of an magnetic field.

The power supply unit 61 supplies a pulsing or continuous current to the electromagnetic part 62 under to the control of the target position controller 42.

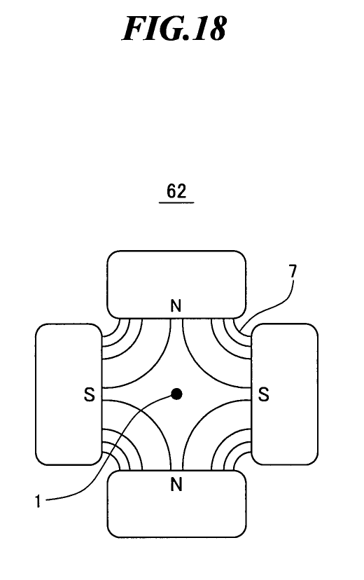

FIG. 18 is a plan view showing the electromagnetic part 62. As shown in FIG. 18, the electromagnetic part 62 includes two pairs of electromagnets oppositely provided in parallel with each other with the track of the target material 1 in between. In these electromagnets, the current directions are determined such that the same magnetic poles face to each other, and thereby, a magnetic field represented by lines of magnetic flux 7 is formed among the four electromagnets. Further, the electromagnets are arranged such that the center of the magnetic field (in other words, the position where the magnetic fields respectively formed by the four electromagnets are cancelled) is on the axis of the plasma generation point, i.e., on the central axis of the magnetic field formed by the electromagnets 19a and 19b.

As shown in FIG. 18, when the charged target material 1 passes through the center of the magnetic field formed by the electromagnetic part 62 in a direction perpendicular to the plane including the lines of magnetic flux 7 (e.g., the direction from the front side toward the rear side of the drawing), the target material 1 cross no lines of magnetic flux 7. Therefore, the target material 1 travels straight without being affected by the magnetic field. On the other hand, when the position of the target material 1 is off the center of the magnetic field, the target material 1 crosses the lines of magnetic flux 7. Accordingly, the charged target material 1 is pushed back toward the center due to the Lorentz force. Then, as shown in FIG. 18, since the density of the lines of magnetic flux 7 gradually increases from the center toward the periphery, as the position where the target material 1 passes through is closer to the periphery, the target material 1 crosses a larger number of lines of magnetic flux 7 and the target material 1 is pushed back toward the center by the greater force. Consequently, the charged target material 1 is subject to the force in the direction toward the lower magnetic flux density (i.e., toward the center of the magnetic field) and the position thereof is focused to the center of the magnetic field.

In order to adjust the center of the magnetic field formed by the electromagnetic part 62 onto the axis of the plasma generation point, intensity of the currents supplied to the four electromagnets may be adjusted, or the position of the electromagnets may be adjusted. Further, in FIG. 17, the position adjustment of the target material 1 may be performed by using permanent magnets in place of the electromagnets according to the same principle.

In the above explanation, the position of the target material 1 has been adjusted by the effect of either the electric field or magnetic field, however, both field effects may be used. For example, as the target position adjustment unit 41 shown in FIG. 14, the electrode pairs 52 and 53 shown in FIG. 16 are provided at the downstream of the electric charge supply unit 17, and the electromagnetic part 62 shown in FIG. 17 is further provided at the downstream of the electrode pairs. Thereby, after the track of the target material 1 is adjusted by the effect of the electric field, the track of the target material 1 can be converged onto the axis of the plasma generation point by the effect of the magnetic field. As a result, the position of the target material 1 can be adjusted with higher accuracy.

In the embodiment, the target position adjustment unit 41 has been provided for adjustment of the position of the target material 1 entering the magnetic field, however, the target position adjustment unit 41 may be used for another purpose.

Here, the frequency “f” at which the droplet target 1 is produced and the repetition operation frequency “f′” at which the laser unit 13 (FIG. 14) oscillates the laser beam 2 in a pulse state are not necessarily the same. For example, while the repetition operation frequency “f′” of the YAG laser generally used in the LPP EUV light source apparatus is about 10 kHz, the frequency “f” of the vibration for producing droplets is about 110 kHz in the case where droplets having a diameter of about 60 μm and dropped at a velocity of about 30 m/s are formed. As described above, typically, the production frequency “f” of droplets is several times to several tens of times the repetition frequency “f””. In such a case, a series of droplets of the target material 1 injected from the target nozzle 12 are applied with the laser beam 2 at intervals of several droplets. Accordingly, droplets of the target material 1 applied with no laser beam 2 are entered around the EUV collector mirror 15, and such a condition is not very preferable in view of debris production. That is, plasma is generated by applying the laser beam 2 to a certain droplet of the target material 1, however, the adjacent droplets are evaporated by the generated thermal energy. Accordingly, the adjacent droplets cause contamination within the vacuum chamber 10 though they do not contribute to the generation of EUV light.

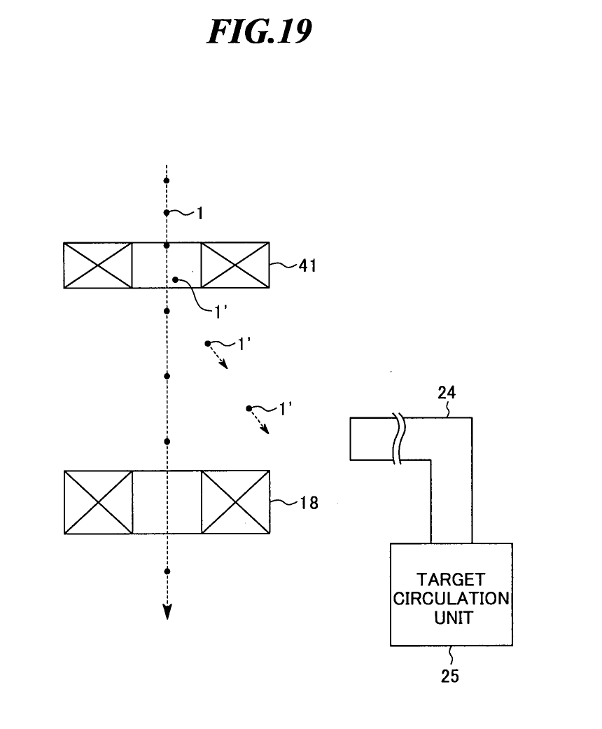

The target position adjustment unit 41 can be used for thinning droplets of the target material 1. That is, as shown in FIG. 19, among the droplets of the target material 1 injected from the target nozzle 12 (FIG. 14), a track of a predetermined droplet of the target material 1′ is changed by the target position adjustment unit 41 into a direction different from the traveling direction of the target material 1 (the direction toward the plasma generation point). Thereby, only the droplets of the target material 1 that coincide with the application timing of the laser beam 2 can enter the plasma generation point. Further, the droplet of the target material 1′ in the changed tracks may be guided toward the target exhaust tube 24, for example, and collected. Afterwards, the droplet of the target material 1 may be refined by the target circulation unit 25 for reuse.

In this manner, the amount of evaporation of the target material 1 near the plasma generation point can be reduced by thinning the unwanted droplets of the target material 1, and thus, the reduction in degree of vacuum (pressure rise) within the vacuum chamber 10 can be prevented and the contamination of parts such as the EUV collector mirror 15 within the vacuum chamber 10 can be suppressed.

In the above explained fourth embodiment of the present invention, the target position adjustment unit has been provided in addition to the extreme ultra violet light source apparatus shown in FIG. 1, however, the same unit may be provided to the extreme ultra violet light source apparatus shown in FIG. 12 or 13. Thereby, the accuracy of the track of the target material 1 can be further improved.

1. An extreme ultra violet light source apparatus that emits extreme ultra violet light by irradiating a target material with a laser beam applied from a laser beam source and thereby turning the target material into plasma, said apparatus comprising:
a target nozzle that injects a target material toward a predetermined plasma generation point;
an electric charge supply unit that charges the target material injected from said target nozzle;
an acceleration unit that accelerates the target material charged by said electric charge supply unit;
a laser oscillator that applies a laser beam to the target material at the plasma generation point so as to generate plasma; and
magnetic field forming means that forms a magnetic field at the plasma generation point, said magnetic field having substantially straight lines of magnetic flux in substantially parallel with a traveling direction of the target material in a track of the target material.

2. The extreme ultra violet light source apparatus according to claim 1, wherein said magnetic field forming means includes:
one set of electromagnets that form a mirror magnetic field at the plasma generation point; and
control means for controlling currents to be supplied to said one set of electromagnets such that the mirror magnetic field formed by said one set of electromagnets has the substantially straight lines of magnetic flux in substantially parallel with the traveling direction of the target material in the track of the target material.

3. The extreme ultra violet light source apparatus according to claim 1, wherein said magnetic field forming means includes:
one set of magnets that form a mirror magnetic field at the plasma generation point, each of said one set of electromagnets including one of an electromagnet, a superconducting magnet, and a permanent magnet; and
at least one magnetic field forming unit that forms an auxiliary magnetic field such that said mirror magnetic field with said auxiliary magnetic field has the substantially straight lines of magnetic flux in substantially parallel with the traveling direction of the target material in the track of the target material.

4. The extreme ultra violet light source apparatus according to claim 3, wherein said at least one magnetic field forming unit is provided between said acceleration unit and said one set of magnets and/or provided between said electric charge supply unit and said acceleration unit.

5. The extreme ultra violet light source apparatus according to claim 1, further comprising:
a target position adjustment unit that is provided between said electric charge supply unit and said plasma generation point, and adjusts a position of the charged target material.

6. The extreme ultra violet light source apparatus according to claim 5, wherein said target position adjustment unit adjusts the position of the charged target material by an effect of an electric field and/or an effect of a magnetic field.
